(19) United States
(12) Patent Application Publication
(10) Pub. No.: US 2024/0155422 A1
(43) Pub. Date: May 9, 2024

(54) Electronic Devices and Corresponding Methods for Disabling a Connected Mode Discontinuous Reception (C-DRX) Mode of Operation Under Network Congestion Conditions

(71) Applicant: Motorola Mobility LLC, Chicago, IL (US)

(72) Inventors: Daniel C Chisu, Franklin Park, IL (US); Yui J Chin, Chicago, IL (US); Armin W Klomsdorf, Chicago, IL (US)

(21) Appl. No.: 17/982,329

(22) Filed: Nov. 7, 2022

(51) Int. Cl. H04W 28/02; H04W 76/28

(52) U.S. Cl. CPC H04W 28/0284; H04W 76/28

(57) ABSTRACT

An electronic device includes a communication device, a connected mode discontinuous reception (C-DRX) module operable with the communication device, and one or more processors operable with the communication device and the C-DRX mode of operation. The one or more processors infer whether network congestion exceeds a predefined threshold from one or more Internet-protocol (IP) and physical layer metrics and disabling the C-DRX mode of operation when the network congestion exceeds the predefined threshold. The one or more processors can also disable the C-DRX mode of operation when user-identified “performance” applications are operating on the one or more processors.

### BACKGROUND

### Technical Field

This disclosure relates generally to wireless communication devices, and more particularly to wireless communication devices capable of operating in a connected mode discontinuous reception (C-DRX) configuration.

### Background Art

The technology associated with wireless communication devices, examples of which include smartphones, smartwatches, and tablet computers, is continually improving. Illustrating by example, while not too long ago such devices included only grey scale liquid crystal diode displays with large, blocky pixels, modern smartphones, tablet computers, and even smart watches include vivid organic light emitting diode (OLED) displays with incredibly small pixels. In addition to voice calls, people use such devices for many different purposes, including maintaining calendars and schedules, handling financial and health care information, “surfing” the web, playing games, and watching television and movies.

The wireless communication networks that facilitate the wireless communication that makes smartphones are able to provide such rich feature sets by handling telephony communications, video communications, data communications, messaging communications, and other types of communications. Generally configured as “multiple access” networks supporting multiple users by sharing network resources, such networks employ many different “behind the scenes” mechanisms to allow many users to share those network resources. Despite their many benefits, data transfer across such networks is not perfect. Instances can even arise where a person has “five bars” of reception but still has trouble loading a webpage. It would be advantageous to have improved wireless communication devices and corresponding methods to remedy these situations.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIG. 3 illustrates several explanatory C-DRX disablement triggers in accordance with one or more embodiments of the disclosure.

FIG. 4 illustrates another explanatory method in accordance with one or more embodiments of the disclosure.

FIG. 5 illustrates explanatory techniques and metrics for determining network congestion sufficient to disable a C-DRX mode of operation in accordance with one or more embodiments of the disclosure.

FIG. 6 illustrates other explanatory techniques and metrics for determining network congestion sufficient to disable a C-DRX mode of operation in accordance with one or more embodiments of the disclosure.

FIG. 7 illustrates another explanatory method in accordance with one or more embodiments of the disclosure.

FIG. 8 illustrates still another explanatory method in accordance with one or more embodiments of the disclosure.

FIG. 9 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to a method for disabling a C-DRX mode of operation when network congestion between an electronic device and a network exceeds a predefined threshold. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction with a network.

It will be appreciated that embodiments of the disclosure described herein may be comprised of one or more conventional processors and unique stored program instructions that control the one or more processors to implement, in conjunction with certain non-processor circuits, some, most, or all of the functions of inferring whether network congestion exceeds a predefined threshold from one or more Internet-protocol (IP) and physical layer metrics and disabling a C-DRX mode of operation when the network congestion exceeds the predefined threshold as described herein. The non-processor circuits may include, but are not limited to, a radio receiver, a radio transmitter, signal drivers, clock circuits, power source circuits, and user input devices. As such, these functions may be interpreted as steps of a method to perform a disablement of a C-DRX mode of operation when one or more processors of an electronic device determine that network congestion exceeds a predefined threshold, or a user-defined application is operating on the one or more processors.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

DRX stands for discontinuous reception. Introduced in an earlier era, DRX is an operating mode that was introduced to reduce power consumption and increase the battery life of wireless communication devices. When in operation, DRX instructs an electronic device to power down most of the network communication circuitry in situations where there are not data packets to be received or transmitted. When operating in the continuous or “C-DRX mode,” the network communication circuitry wakes up for communication only at specified times.

This DRX “feature” can be enabled when the wireless communication device is in one of two different network connection states. The first is called a “connected mode,” while the second is called the “idle mode.” When using the connected mode discontinuous reception (C-DRX), the network communication circuitry listens to the network in accordance with a specific pattern determined by the network. By contrast, the idle mode requires a page signal from the network to for network communication circuitry to determine if it needs to connect to the network for communication.

In effect, C-DRX prevents the network from communicating with the wireless communication device when the device is asleep or in a power savings mode. C-DRX was specifically introduced as a standard under the 3GPP operating protocol to allow an electronic device to remain connected to the network while still conserving battery power by precluding the wireless communication device from continually communicating with the network.

A problem with C-DRX is that it makes it difficult for the network to schedule the wireless communication device for data delivery as a function of user interaction. If, for example, a person is browsing the web and requesting content from different sources, the scheduling for each of these sources will be different. In a congestion scenario, which can be due to either radio frequency (RF) congestion or “backhaul congestion,” C-DRX will make the device go to sleep. (RF congestion occurs when many users operate on the same cell resource, which causes network scheduling to decrease to provide service to all active users. Backhaul congestion is a bottleneck condition on network servers and links between network nodes whenever link capacity is reached. The results of backhaul congestion may manifest in IP packet fragmentation and segment loss.)

While saving battery power, C-DRX can exacerbate the network congestion problem if the network cannot schedule data for a device while in a sleep cycle. While voice communications have a guaranteed quality of service that takes precedence over data communications and might not see a problem, certain applications and activities like surfing the web are at a disadvantage because they are not continually scheduled like voice and video communications.

Advantageously, embodiments of the disclosure provide a solution to this problem by actually disabling the C-DRX mode of operation when network congestion reaches a predefined threshold. In one or more embodiments, one or more processors of an electronic device determine whether network congestion exceeds the predefined threshold. When it does, in one or more embodiments the one or more processors disable the C-DRX mode of operation in the electronic device. Advantageously, when operating without C-DRX a better performance occurs than in electronic devices having a high C-DRX cycle length.

In one or more embodiments, an electronic device includes a communication device and one or more processors operable with the communication device. In one or more embodiments, the one or more processors are capable of operating in a C-DRX mode of operation. In one or more embodiments, the one or more processors infer whether network congestion exceeds a predefined threshold from one or more IP and physical layer metrics. When the one or more processors infer from these data that the network congestion exceeds the predefined threshold, in one or more embodiments they disable the C-DRX mode of operation.

In other embodiments, disablement of the C-DRX mode of operation is user defined. Illustrating by example, if a user of an electronic device has a favorite application that runs better when the C-DRX mode of operation is not supported, in one or more embodiments they can designate, using user settings, that the C-DRX mode of operation be disabled when the application is active. Accordingly, in one or more embodiments a user can use menus and other control settings of the electronic device to disable the C-DRX mode of operation when the application is active. In one or more embodiments, the can simply designate the augmented reality glasses application to operate in a “performance mode,” which, behind the scenes, disabled the C-DRX mode of operation when the augmented reality glasses application is active in one or more embodiments.

Accordingly, in one or more embodiments a method in an electronic device disabled the C-DRX mode of operation in the electronic device when either one or more processors of the electronic device determine that network congestion exceeds the predefined threshold, or a user-identified application is operating on the one or more processors. In one or more embodiments, the user can deliver user input to a user interface of the electronic device that designates the user-identified applications operate in a performance mode disabling the C-DRX mode of operation on a per application basis. The C-DRX mode of operation can then be reenabled when the user-identified applications cease operating on the one or more processors. In one or more embodiments, the disablement of the C-DRX mode of operation in this “performance mode” only occurs when the energy storage device of the electronic device is charged beyond a predefined energy storage threshold, i.e., the electronic device has sufficient energy stored in the energy storage device or is charging, to ensure that the performance mode does not drive the energy storage level to zero.

Advantageously, embodiments of the disclosure optimize a user experience when operating a wireless communication device for latency and throughput when the wireless communication device experiences network congestion. This advantage results regardless of whether the network congestion is RF congestion or backhaul congestion. In one or more embodiments, the determination of network congestion is based upon the wireless communication device monitoring certain IP and physical layer metrics that are known to affect latency and throughput. In one or more embodiments, one or more processors of the wireless communication device weigh these data to determine if network congestion exists. The one or more processors can also determine a network congestion probability score.

Another advantage offered by embodiments of the disclosure is that high priority applications can be designated to control disablement of the C-DRX mode of operation on the electronic device side as well. By allowing the end user to control a “performance mode” on a per application basis, the one or more processors can use this designation to disable the C-DRX mode of operation when the applications are active. This allows the user to achieve a “true performance mode” for certain applications. Other advantages offered by embodiments of the disclosure will be described below. Still others will be obvious to those of ordinary skill in the art having the benefit of this disclosure.

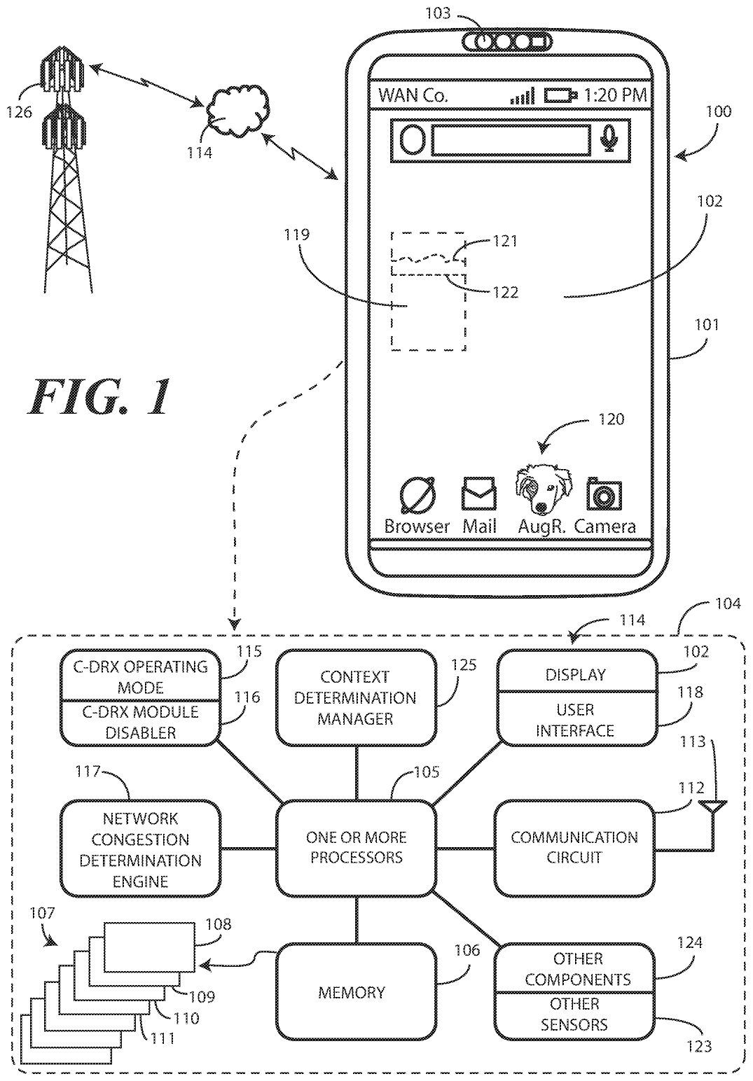

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, laptop computers, desktop computers, servers, networked computers, multimedia players, and so forth. Still other types of electronic devices can be configured in accordance with one or more embodiments of the disclosure as will be readily appreciated by those of ordinary skill in the art having the benefit of this disclosure.

The electronic device 100 includes a device housing 101. In one or more embodiments the device housing 101 is manufactured from a rigid material such as a rigid thermoplastic, metal, or composite material, although other materials can be used. In other embodiments, the device housing 101 can have a flexible display coupled thereto that slides around major and minor surface of the device housing 101.

In still other embodiments, the device housing 101 will be manufactured from a flexible material such that it can be bent and deformed. Where the device housing 101 is manufactured from a flexible material or where the device housing 101 includes a hinge, the display 102 can be manufactured on a flexible substrate such that it bends. Still other constructs will be obvious to those of ordinary skill in the art having the benefit of this disclosure.

In the illustrative embodiment of FIG. 1, the electronic device 100 includes a single device housing 101. However, in other embodiments two or more device housings can be included. Illustrating by example, in other embodiments an electronic device includes a first device housing and a second device housing. In one or more embodiments, a hinge assembly couples the first device housing to the second device housing. In one or more embodiments, the first device housing is selectively pivotable about the hinge assembly relative to the second device housing. For example, in one or more embodiments the first device housing is selectively pivotable about the hinge assembly between a closed position and an axially displaced open position. In still other embodiments, multiple hinges can be incorporated into the electronic device to allow it to be folded in multiple locations.

This illustrative electronic device 100 of FIG. 1 includes a display 102. The display 102 can optionally be touch-sensitive. In one embodiment where the display 102 is touch-sensitive, the display 102 can serve as a primary user interface of the electronic device 100. Users can deliver user input to the display 102 of such an embodiment by delivering touch input from a finger, stylus, or other objects disposed proximately with the display 102.

In one embodiment, the display 102 is configured as an organic light emitting diode (OLED) display fabricated on a substrate. Where the electronic device 100 is flexible or deformable or hinged, the substrate can comprise flexible plastic substrate, thereby making the display 102 a flexible display or foldable display that deforms when the first device housing pivots about the hinge assembly relative to the second device housing.

Users can deliver user input to the display 102, which serves as a user interface for the electronic device 100. In one embodiment, users can deliver user input to the display 102 of such an embodiment by delivering touch input from a finger, stylus, or other objects disposed proximately with the display 102. In one embodiment, the display 102 is configured as an active-matrix organic light emitting diode (AMOLED) display. However, it should be noted that other types of displays, including liquid crystal displays, would be obvious to those of ordinary skill in the art having the benefit of this disclosure.

Features can be incorporated into the device housing 101. Examples of such features include an imager 103 or an optional speaker port. A user interface component, which may be a button or touch sensitive surface, can also be disposed along the device housing 101. Other features can be added as well.

In one or more embodiments, the imager 103 is configured as an intelligent imager. Where configured as an intelligent imager, the imager 103 can capture one or more images of environments about the electronic device 100 to determine whether the object matches predetermined criteria. For example, the imager 103 can operate as an identification module configured with optical recognition such as image recognition, character recognition, visual recognition, facial recognition, color recognition, shape recognition and the like. Advantageously, the imager 103 can use these processes to identify triggering events causing a C-DRX mode of operation disabler 116 to disable a C-DRX mode of operation 115.

A block diagram schematic 104 of the electronic device 100 is also shown in FIG. 1. The block diagram schematic 104 can be configured as a printed circuit board assembly disposed within the device housing 101 of the electronic device 100. Various components can be electrically coupled together by conductors, or a bus disposed along one or more printed circuit boards.

It should be noted that the block diagram schematic 104 includes many components that are optional, but which are included in an effort to demonstrate how varied electronic devices configured in accordance with embodiments of the disclosure can be. Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components, and still be within the scope of the present disclosure.

In one or more embodiments, the electronic device 100 includes one or more processors 105. The one or more processors 105 can be a microprocessor, a group of processing components, one or more Application Specific Integrated Circuits (ASICs), programmable logic, or other type of processing device. The one or more processors 105 can be operable with the various components of the electronic device 100. The one or more processors 105 can be configured to process and execute executable software code to perform the various functions of the electronic device 100. A storage device, such as memory 106, can optionally store the executable software code used by the one or more processors 105 during operation.

In one or more embodiments, the one or more processors 105 are further responsible for performing the primary functions of the electronic device 100. For example, in one embodiment the one or more processors 105 comprise one or more circuits operable to present presentation information, such as images, text, and video, on the display 102. The executable software code used by the one or more processors 105 can be configured as one or more modules 107 that are operable with the one or more processors 105. Such modules 107 can store instructions, control algorithms, and so forth.

In one embodiment, the one or more processors 105 are responsible for running the operating system environment 108. The operating system environment 108 can include a kernel, one or more drivers 109, and an application service layer 110, and an application layer 111. The operating system environment 108 can be configured as executable code operating on one or more processors or control circuits of the electronic device 100.

In one or more embodiments, the one or more processors 105 are responsible for managing the applications of the electronic device 100. The applications of the application layer 111 can be configured as clients of the application service layer 110 to communicate with services through application program interfaces (APIs), messages, events, or other inter-process communication interfaces.

In this illustrative embodiment, the electronic device 100 also includes a communication device 112 that can be configured for wired or wireless communication with one or more other devices or networks. The networks can include a wide area network, a local area network, and/or personal area network. The communication device 112 may also utilize wireless technology for communication, such as, but are not limited to, peer-to-peer or ad hoc communications, and other forms of wireless communication such as infrared technology. The communication device 112 can include wireless communication circuitry, one of a receiver, a transmitter, or transceiver, and one or more antennas 113.

The one or more antennas 113 can take a variety of forms. Using 5G communication as an example, the one or more antennas 113 can comprise a MIMO antenna array comprising a plurality of antenna elements configured for MIMO communication with other remote electronic devices, servers, base stations, and so forth, across a network 114. Illustrating by example, the MIMO antenna array might consist of four antenna elements. However, it should be noted that embodiments of the disclosure the electronic device 100 can be equipped with six antenna element, eight antenna element, or higher numbers of antenna elements.

In one or more embodiments, the one or more antennas 113 also include at least one mmWave antenna assembly. In one or more embodiments, the mmWave antenna assembly comprises an array of mmWave antenna elements. In one or more embodiments, the array of mmWave antenna elements defines a N×1 matrix, where N represents a number of mmWave antenna elements of the array of mmWave antenna elements. Other antenna configurations for communicating with the network 114 will be obvious to those of ordinary skill in the art having the benefit of this disclosure.

In one or more embodiments, a C-DRX mode of operation 115 can cause the communication device 112 to enter an idle, sleep, or power saving mode that prevents the communication device 112 from listening to the network 114 except at certain intervals. The C-DRX mode of operation 115 helps the electronic device 100 save power by preventing the communication device 112 from communicating with the network 114 continually. The C-DRX mode of operation 115 can also keep the network 114 from waking the communication device 112 except as within those sleep cycles configured by the network to save power as well.

When the C-DRX mode of operation 115 is active, the electronic device 100 can reduce its power consumption by periodically entering a sleep state. The C-DRX mode of operation 115 can do this in a variety of ways, including by increasing the length of the C-DRX cycle, increasing the timer length associated with the C-DRX cycle, or by adjusting other parameters. At the same time, when the C-DRX mode of operation 115 is active, this can reduce the frequency at which serving node 126 measurements are taken and/or reported back to the serving node 126. Illustrating by example, depending upon the length of the C-DRX cycle, less frequent measurement reports may be reported back to the serving node 126, thereby delaying handover procedures and in some instances inducing cell link failures and dropped calls.

In effect, the C-DRX mode of operation 115 prevents the network 114 from looking for the electronic device 100 when the electronic device 100 is asleep or in a power savings mode. Illustrating by example, if a period of time has passed since data was received, the C-DRX mode of operation 115 may automatically become active. When this occurs, the network 114 will tell the communication device 112 of the electronic device 100 to go to sleep for certain intervals. Moreover, when the C-DRX mode of operation 115 is active the network 114 will not wake the communication device 112 of the electronic device 100 except during those certain intervals to save battery.

A problem with the C-DRX mode of operation 115 is that it makes it difficult for the network 114 to schedule the electronic device 100 for data delivery as a function of user interaction. If, for example, a person is browsing the web and requesting content from different sources, the scheduling for each of these sources will be different. In a congestion scenario, which can be due to either radio frequency (RF) congestion or “backhaul congestion,” an active C-DRX mode of operation 115 will make the electronic device 100 go to sleep.

While in theory saving battery power, the C-DRX mode of operation 115 can exacerbate the network congestion problem. The communication device 112 will wake up to consume data, for example, but the network 114 still needs to schedule the electronic device 100 and has old data still waiting to be sent as well. While voice communications have a guaranteed quality of service that takes precedence over data communications and might not see a problem, certain applications and activities like surfing the web are at a disadvantage because they are not continually scheduled like voice and video communications.

Advantageously, embodiments of the disclosure provide a solution to this problem by providing a C-DRX mode of operation disabler 116 that is operable with the one or more processors 105 and a network congestion determination engine 117. In one or more embodiments, the network congestion determination engine 117 infers whether network congestion exceeds a predefined threshold based upon one or more factors, several of which will be described below with reference to FIG. 3. In one or more embodiments, the network congestion determination engine 117 infers whether network congestion exceeds the predefined threshold from one or more IP and physical layer metrics.

In one or more embodiments, when the network congestion determination engine 117 infers that the network congestion exceeds the predefined threshold, the C-DRX mode of operation disabler 116 disables the C-DRX mode of operation 115. Advantageously, when operating without the C-DRX mode of operation 115, a substantially better performance occurs than in electronic devices having a high C-DRX cycle length. This is true because certain latency intensive and/or real-time applications such as those used with augmented reality or virtual reality glasses work better when the C-DRX mode of operation 115 is disabled.

In one or more embodiments, the electronic device 100 includes the communication device 112 and the one or more processors 105 that are operable with the communication device 112. In one or more embodiments, the one or more processors 105 use the network congestion determination engine 117 to infer whether network congestion exceeds a predefined threshold from one or more IP and physical layer metrics. When the one or more processors 105 infer from these data that the network congestion exceeds the predefined threshold, in one or more embodiments the C-DRX mode of operation disabler 116 disables the C-DRX mode of operation 115.

In other embodiments, disablement of the C-DRX mode of operation 115 is user defined. Illustrating by example, if a user of the electronic device 100 has a favorite application that runs better when the C-DRX mode of operation 115 is not supported in one or more embodiments the C-DRX mode of operation disabler 116 can designate, using user settings, that the C-DRX mode of operation 115 be disabled when the application is active.

In one or more embodiments a user can use menus and other control settings of the electronic device to cause the C-DRX mode of operation disabler 116 to disable the C-DRX mode of operation 115 when the application is active. In one or more embodiments, the user can simply designate the selected application to operate in a “performance mode,” which, behind the scenes, causes the C-DRX mode of operation disabler 116 to disable the C-DRX mode of operation 115 when the application is active in one or more embodiments.

Accordingly, in one or more embodiments a method in the electronic device 100 disables the C-DRX mode of operation 115 in the electronic device 100 when either the one or more processors 105 of the electronic device 100 determine that network congestion exceeds the predefined threshold, or a user-identified application is operating on the one or more processors 105. In one or more embodiments, the user can deliver user input to a user interface 118 of the electronic device 100 that designates the user-identified applications operate in a performance mode disabling the C-DRX mode of operation 115 on a per application basis. The C-DRX mode of operation 115 can then be reenabled when the user-identified applications cease operating on the one or more processors 105. In one or more embodiments, the disablement of the C-DRX mode of operation 115 in this “performance mode” only occurs when the energy storage device 119 of the electronic device 100 is charged beyond a predefined energy storage threshold to ensure that the performance mode does not drive the energy storage level to zero.

Advantageously, embodiments of the disclosure optimize a user experience when operating an electronic device 100 for latency and throughput when the electronic device 100 experiences network congestion. This advantage results regardless of whether the network congestion is RF congestion or backhaul congestion. In one or more embodiments, the determination of network congestion is based upon the network congestion determination engine 117 monitoring certain IP and physical layer metrics that are known to affect latency and throughput. In one or more embodiments, the network congestion determination engine 117 of the electronic device 100 weigh these data to determine if network congestion exists. The network congestion determination engine 117 can even determine a network congestion probability score.

Another advantage offered by embodiments of the disclosure is that high priority applications can be designated to control disablement of the C-DRX mode of operation 115 on the electronic device 100 side as well. By allowing the end user to control a “performance mode” on a per application basis, the one or more processors 105 can use this designation to disable the C-DRX mode of operation 115 when the applications are active. In one or more embodiments, the user can set a “performance mode” that indirectly disabled the C-DRX mode of operation 115 when there is no network congestion. This allows the user to achieve a “true performance mode” for certain applications.

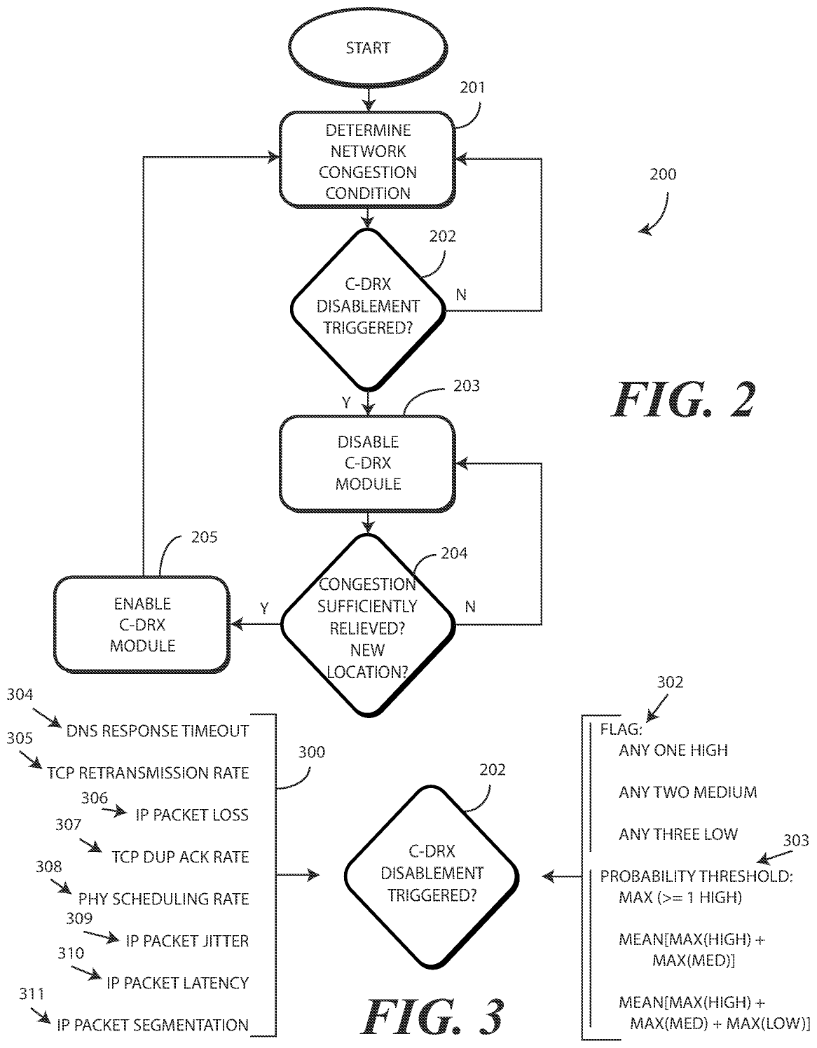

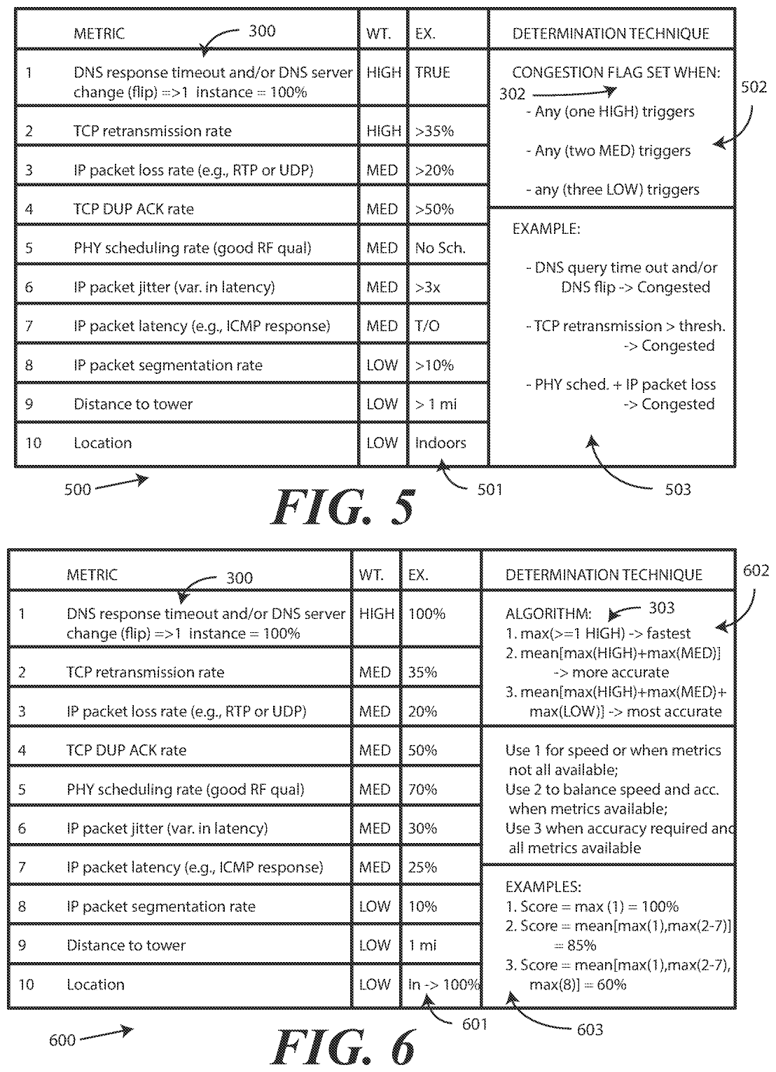

In one or more embodiments, the network congestion determination engine 117 infers whether network congestion exceeds the predefined threshold by weighting the one or more IP and physical layer metrics hierarchically as one or more weighted metrics. Examples of these weighted metrics will be described below with reference to FIGS. 5 and 6. In one or more embodiments, the network congestion determination engine 117 further infers whether the network congestion exceeds the predefined threshold by calculating a network congestion probability score from the one or more weighted metrics. When the electronic device 100 includes the energy storage device 119, in one or more embodiments the disablement of the C-DRX mode of operation 115 occurs only when a latency-sensitive application 120 is operating on the one or more processors 105 and the energy storage device 119 is charging or has an energy storage level 121 exceeding an energy storage threshold 122. Examples of how this can occur in the electronic device 100 will be described in more detail below with reference to the FIGS. 2, 4, and 8. Other techniques of disabling the C-DRX mode of operation 115 will be obvious to those of ordinary skill in the art having the benefit of this disclosure.

Various sensors 123 can be operable with the one or more processors 105. One example of a sensor that can be included with the various sensors 123 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 105, to detect an object in close proximity with—or touching—the surface of the display 102 or the device housing 101 of the electronic device 100 by establishing electric field lines between pairs of capacitive sensors and then detecting perturbations of those field lines.

Another example of a sensor that can be included with the various sensors 123 is a geo-locator that serves as a location detector. In one embodiment, location detector determines location data. Location can be determined by capturing the location data from a constellation of one or more earth orbiting satellites, or from a network of terrestrial base stations to determine an approximate location. The location detector may also be able to determine location by locating or triangulating terrestrial base stations of a traditional cellular network, or from other local area networks, such as Wi-Fi networks.

Another example of a sensor that can be included with the various sensors 123 is an orientation detector operable to determine an orientation and/or movement of the electronic device 100 in three-dimensional space. Illustrating by example, the orientation detector can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of an electronic device 100 in three-dimensional space by, for example, detecting a gravitational direction. In addition to, or instead of, an accelerometer, an electronic compass can be included to detect the spatial orientation of the electronic device 100 relative to the earth's magnetic field. Similarly, one or more gyroscopes can be included to detect rotational orientation of the electronic device 100.

Thus, the one or more sensors 123 can include one or more of an accelerometer, gyroscope, and/or inertial motion to determine an orientation of the electronic device 100 in three-dimensional space. This orientation determination can include measurements of azimuth, plumb, tilt, velocity, angular velocity, acceleration, and angular acceleration, of the device housing 101, or where the electronic device 100 is configured as a bendable electronic device, one of the first device housing or the second device housing.

In one or more embodiments, the orientation determination signals are delivered to the one or more processors 105, which report the determined orientations to the various modules, components, and applications operating on the electronic device 100. In one or more embodiments, the one or more processors 105 can be configured to deliver a composite orientation that is an average or other combination of the orientation of orientation determination signals indicative of a triggering event to these components.

Other components 124 operable with the one or more processors 105 can include output components such as video outputs, audio outputs, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio outputs such as a loudspeaker disposed behind a speaker port or other alarms and/or buzzers and/or a mechanical output component such as vibrating or motion-based mechanisms.

Other components 124 of the electronic device 100 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the display are being actuated. Alternatively, touch sensors disposed along the device housing 101 can be used to determine whether the electronic device 100 is being touched at side edges or major faces of the electronic device 100 by a surface, hands, keys, or other objects. The touch sensors can include surface and/or housing capacitive sensors in one embodiment.

The other components 124 included with the electronic device 100 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other components 124 include a gravity detector. For example, as one or more accelerometers and/or gyroscopes may be used to show vertical orientation, constant, or a measurement of tilt relative to gravity. The other components 124 operable with the one or more processors 105 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

The other components 124 can also include proximity sensors. The proximity sensors fall in to one of two camps: active proximity sensors and “passive” proximity sensors. Either the proximity detector components or the proximity sensor components can be generally used for gesture control and other user interface protocols.

The other components 124 can optionally include a barometer operable to sense changes in air pressure due to elevation changes or differing pressures of the electronic device 100. The other components 124 can also optionally include a light sensor that detects changes in optical intensity, color, light, or shadow in the environment of an electronic device. This can be used to make inferences about operating contexts of the electronic device 100 such as weather or colors, walls, fields, and so forth, or other cues.

An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A device context determination manager 125 can then be operable with the various sensors 123 to detect, infer, capture, and otherwise determine persons and actions that are occurring in an environment about the electronic device 100. For example, where included one embodiment of the device context determination manager 125 determines assessed contexts and frameworks using adjustable algorithms of context assessment employing information, data, and events. These assessments may be learned through repetitive data analysis. Alternatively, a user may employ a menu or user controls via the display 102 to enter various parameters, constructs, rules, and/or paradigms that instruct or otherwise guide the device context determination manager 125 in determining operating context that can be used as inputs for the C-DRX mode of operation disabler 116 to disable the C-DRX mode of operation 115 as a function of one or more factors, examples of which will be described below with reference to FIG. 3. The device context determination manager 125 can comprise an artificial neural network or other similar technology in one or more embodiments.

In one or more embodiments, the electronic device 100 includes as individual components the C-DRX mode of operation disabler 116, the network congestion determination engine 117, and the context determination manager 125. In one or more embodiments, the network congestion determination engine 117 and the context determination manager 125 are operable to determine an operating context of the electronic device 100. Thereafter, the C-DRX mode of operation disabler 116 is operable to disable the C-DRX mode of operation 115 as a function of the operating context identified by the network congestion determination engine 117. Examples of such operating contexts will be described below with reference to FIG. 3.

In one or more embodiments, the C-DRX mode of operation disabler 116, the network congestion determination engine 117, and the context determination manager 125 are each operable with the one or more processors 105. In some embodiments, the one or more processors 105 can control the C-DRX mode of operation disabler 116, the network congestion determination engine 117, and the context determination manager 125. In other embodiments, C-DRX mode of operation disabler 116, the network congestion determination engine 117, and the context determination manager 125 can operate independently. The C-DRX mode of operation disabler 116, the network congestion determination engine 117, and the context determination manager 125 can receive data from the various sensors 123. In one or more embodiments, the one or more processors 105 are configured to perform the operations of the C-DRX mode of operation disabler 116, the network congestion determination engine 117, and the context determination manager 125.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices configured in accordance with embodiments of the disclosure may include various other components not shown in FIG. 1 or may include a combination of two or more components or a division of a particular component into two or more separate components, and still be within the scope of the present disclosure.

Turning now to FIG. 2, illustrated therein is one explanatory method 200 for an electronic device, one example of which is the electronic device (100) of FIG. 1, in accordance with one or more embodiments of the disclosure. Beginning at step 201, one or more processors of the electronic device determine whether a network congestion condition exists. Step 201 checks for network congestion because the electronic device could be operating on a shared wireless resource that is experiencing network congestion. Embodiments of the disclosure contemplate that this network congestion can cause degradation in data throughput and latency. Network congestion can also result in the network being unable to schedule electronic devices quickly enough to serve all users sharing the resource while avoiding packet loss.

As noted above, this network congestion can be caused by two types of congestion: RF congestion and backhaul congestion. RF congestion occurs when many users operate on the same network node resource. In one or more embodiments, this cases network scheduling to decreased to provide service to all active users. Backhaul congestion, by contrast, occurs when bottlenecks on network servers and links between network nodes occur when link capacity is reached.

Decision 202 determines whether disablement of a C-DRX mode of operation is triggered. In one or more embodiments, the disablement of the C-DRX mode of operation occurs when the network congestion exceeds a predefined threshold. In one or more embodiments, this determination comprises monitoring certain IP and physical layer metrics that are known to affect latency and throughput, and thereafter weighting them to determine if the network is congested beyond a predefined threshold.

In other embodiments, this determination can comprise determining a network congestion probability score based upon factors such as a domain name system (DNS) timeout and/or DNS server changes (flips), transmission control protocol (TCP) retransmission rates, IP packet loss rates, e.g., real time transport protocol (RTP) or user datagram protocol (UDP), TCP duplicate acknowledgment (DUP ACK) rates, physical layer (PHY) scheduling rates (while in good RF channel quality), IP packet jitter (variation in latency between packets), IP packet latency, e.g., internet control message protocol (ICMP) responsive packet latency, and IP packet segmentation rates that indicate backhaul congestion.

Turning briefly to FIG. 3, illustrated therein are some explanatory C-DRX mode of operation disablement triggers 300 in accordance with one or more embodiments of the disclosure. In some embodiments, the C-DRX mode of operation can be disabled when any of these triggers 300 occur. In other embodiments, a C-DRX disablement flag 302 can be sent when certain prioritized triggers 300 occur. In still other embodiments, a probability threshold 303 can be calculated using one or more of these triggers 300 as inputs to determine when the C-DRX mode of operation is disabled. Each will be explained in more detail below.

Illustrating by example, in one or more embodiments when a DNS response timeout 304 occurs, decision 202 determines that the C-DRX mode of operation should be disabled. In one or more embodiments, as little as a single instance of a DNS response timeout 304 is sufficient to cause the C-DRX mode of operation to be disabled. In other embodiments, user settings can adjust this predefined threshold upward so that two, three, or more DNS response timeouts 304 are required to cause the C-DRX mode of operation to be disabled.

Similarly, in one or more embodiments where the TCP retransmission rate 305 increases beyond a threshold, one example of which is thirty-five percent, decision 202 will also determine that the C-DRX mode of operation should be disabled. As with the DNS response timeout 304, in other embodiments ser settings can adjust this predefined threshold. Thus, in some embodiments a twenty percent TCP retransmission rate 305 will cause the C-DRX mode of operation to be disabled, while in other embodiments a forty percent TCP retransmission rate 305 will cause the C-DRX mode of operation to be disabled, and so forth.

If IP packet loss 306 gets too great, such as over twenty percent be it RTP or UDP packet loss, in one or more embodiments decision 202 determines that the C-DRX mode of operation should be disabled. User settings can adjust this predefined threshold of twenty percent upward or downward in one or more embodiments.

If the TCP DUP ACK rate 307 gets too high, such as over fifty percent, decision 202 can also determine that the C-DRX mode of operation should be disabled. User settings can change this predefined threshold as well.

If the PHY scheduling rate 308 while in good RF channel quality gets too sparse, such as may be the case when PHY scheduling is not occurring, decision 202 can also determines that the C-DRX mode of operation should be disabled. User settings can change this predefined threshold in one or more embodiments.

In one or more embodiments, when IP packet jitter 309, which measures the variation in latency between received data packets, exceeds a predefined threshold decision 202 can cause the C-DRX mode of operation to be disabled. In one or more embodiments, the predefined threshold associated with IP packet jitter 309 is about at least three times its normal rate, although other predefined thresholds can be defined by a user by delivering user input to the user interface of an electronic device as well.

Similar to IP packet jitter 309 in other embodiments IP packet latency 310, examples of which include ICMP responses, can be used as a C-DRX mode of operation disablement trigger 300. Illustrating by example, if the IP packet latency 310 results in an ICMP response timeout, decision 202 can cause disablement of the C-DRX mode of operation. User settings can adjust this single time out up or down as desired by a user.

IP packet segmentation rate 311, which is indicative of backhaul congestion, can also be used as a C-DRX mode of operation disablement trigger 300. In one or more embodiments, when the IP packet segmentation rate 311 exceeds ten percent, decision 202 disables the C-DRX mode of operation. User settings can adjust this ten percent predefined threshold higher or lower. While these C-DRX mode of operation disablement triggers 300 can be used alone to determine whether the C-DRX mode of operation should be disabled, in other embodiments they can be used in combination. Illustrating by example, in one or more embodiments one or more of the C-DRX mode of operation disablement triggers 300 can be used to set a C-DRX mode of operation disablement flag 302 causing decision 202 to disable the C-DRX mode of operation

Illustrating by example, in one or more embodiments the C-DRX mode of operation disablement triggers 300 are prioritized. DNS response timeout 304 triggers may be prioritized as “high” priority triggers, while all other C-DRX mode of operation disablement triggers 300 except the IP packet segmentation rate 311 are prioritized as “medium” priority C-DRX mode of operation disablement triggers. The IP packet segmentation rate 311 trigger is then considered a “low” priority C-DRX mode of operation disablement trigger 300.

In one or more embodiments, the C-DRX mode of operation disablement flag 302 is set when the high priority trigger, i.e., the DNS response timeout 304, occurs. In one or more embodiments the C-DRX mode of operation disablement flag 302 is set when the DNS response timeout 304 only occurs a single time.

By contrast, in one or more embodiments the C-DRX mode of operation disablement flag 302 is set when any two “medium” priority C-DRX mode of operation disablement triggers occur. Illustrating by example, if IP packet loss 306 exceeds twenty percent, and if the TCP retransmission rate 305 exceeds thirty-five percent, in one or more embodiments the C-DRX mode of operation disablement flag 302 will be set, thereby causing decision 202 to disable the C-DRX mode of operation. In one or more embodiments, this occurs even when no “high” priority C-DRX mode of operation disablement triggers 300 have been triggered.

Turning briefly to FIG. 5, illustrated therein is a table 500 of these C-DRX mode of operation disablement triggers 300 showing explanatory predefined thresholds 501 for each, as well as formulae 502 to set the C-DRX mode of operation disablement flag 302. Examples 503 of when the C-DRX mode of operation disablement flag 302 might be set are provided as well. It should be known that these explanatory predefined thresholds 501 are illustrative only, as numerous others will be obvious to those of ordinary skill in the art having the benefit of this disclosure. Additionally, user settings can be delivered to a user interface of an electronic device to change these predefined thresholds 501 in one or more embodiments.

In a similar vein, when any three “low” priority C-DRX mode of operation disablement triggers 300 occur the C-DRX mode of operation disablement flag 302 will be set as well. While only one low priority C-DRX mode of operation disablement trigger flag is shown in FIG. 3, numerous others will be obvious to those of ordinary skill in the art having the benefit of this disclosure. Illustrating by example, three low priority C-DRX mode of operation disablement triggers 300 are shown in the tables (500,600) of FIGS. 5-6.

In still other embodiments, a probability threshold 303 can be determined from the C-DRX mode of operation disablement triggers 300. In one or more embodiments, the probability threshold can be determined from the same prioritized C-DRX mode of operation disablement triggers 300. Once again, DNS response timeout 304 triggers may be prioritized as “high” priority triggers, while all other C-DRX mode of operation disablement triggers 300 except the IP packet segmentation rate 311 are prioritized as “medium” priority C-DRX mode of operation disablement triggers. The IP packet segmentation rate 311 trigger is then considered a “low” priority C-DRX mode of operation disablement trigger 300.

In one or more embodiments, the probability threshold 303 calculates the maximum of anu of the high priority C-DRX mode of operation disablement triggers 300. Thus, if the high priority trigger, i.e., the DNS response timeout 304, occurs, in one or more embodiments the probability threshold 303 changes from zero to one hundred percent. In one or more embodiments, this occurs when the DNS response timeout 304 only occurs a single time. In one or more embodiments, this “high factor only” probability threshold is used when speed is of the utmost importance in decision 202 determining whether the C-DRX mode of operation should be disabled.

In other embodiments where a balance between speed and accuracy is desired, the “medium” priority C-DRX mode of operation disablement triggers 300 are factored in with the high priority C-DRX mode of operation factors. Illustrating by example, in one or more embodiments an average of the maximum high priority C-DRX mode of operation disablement factors and the maximum of the medium priority C-DRX mode of operation disablement factors are considered. Thus, if the TCP retransmission rate 305 was forty percent, and there were no DNS response timeouts 304, the probability threshold 303 would be forty percent. When a DNS response timeout 304 occurred, the probability threshold 303 would jump to one hundred percent, and so forth.

When ultimate accuracy is required and sufficient time for calculation is available, the probability threshold 303 can take into account each of the high, the medium, and the priority disablement triggers. Illustrating by example, in one or more embodiments an average of the maximum of each of these factors is used to calculate the probability score. Thus, if the TCP retransmission rate 305 was forty percent while the IP packet segmentation rate 311 was ten percent, and there were no DNS response timeouts 304, the probability threshold 303 would be twenty-five percent. When a DNS response timeout 304 occurred, the probability threshold 303 would jump to one hundred percent, and so forth.

In one or more embodiments, decision 202 determines that the C-DRX mode of operation should be disabled when the probability threshold 303 exceeds fifty percent. However, as with other IP and physical layer metrics described above, user settings can be used to adjust this predefined threshold up or down as desired.

Turning briefly to FIG. 6, illustrated therein is a table 600 of showing explanatory predefined triggers 601 for each, as well as formulae 502 determine the probability threshold 303. Examples 603 of calculations for the probability threshold 303 are provided as well. It should be known that these explanatory predefined thresholds 601 are illustrative only, as numerous others will be obvious to those of ordinary skill in the art having the benefit of this disclosure. Additionally, user settings can be delivered to a user interface of an electronic device to change these predefined thresholds 601 in one or more embodiments.

Turning now back to FIG. 2, in one or more embodiments when decision 202 determines that the network congestion exceeds the predefined threshold—be it using individual C-DRX mode of operation disablement triggers (300) alone, in combination to set a C-DRX mode of operation disablement flag (302), or in combination to calculate a probability threshold (303)—step 203 then disables the C-DRX mode of operation.

In one or more embodiments, the disablement occurring at step 203 is location based, and continues so long as the electronic device remains in a predefined network location. Additionally, the disablement occurring at step 203 will cease when the network congestion determined at step 201 to exceed a predefined threshold at decision 202 falls below that predefined threshold. Accordingly, in one or more embodiments the disabling of step 203 will continue as long as the network congestion exceeds the predefined threshold or the electronic device remains within a singular network location, as determined at decision 204. Step 205 then re-enables the C-DRX mode of operation when the network congestion falls below the predefined threshold or when the electronic device moves to a new network location, each of which is determined at decision 204.

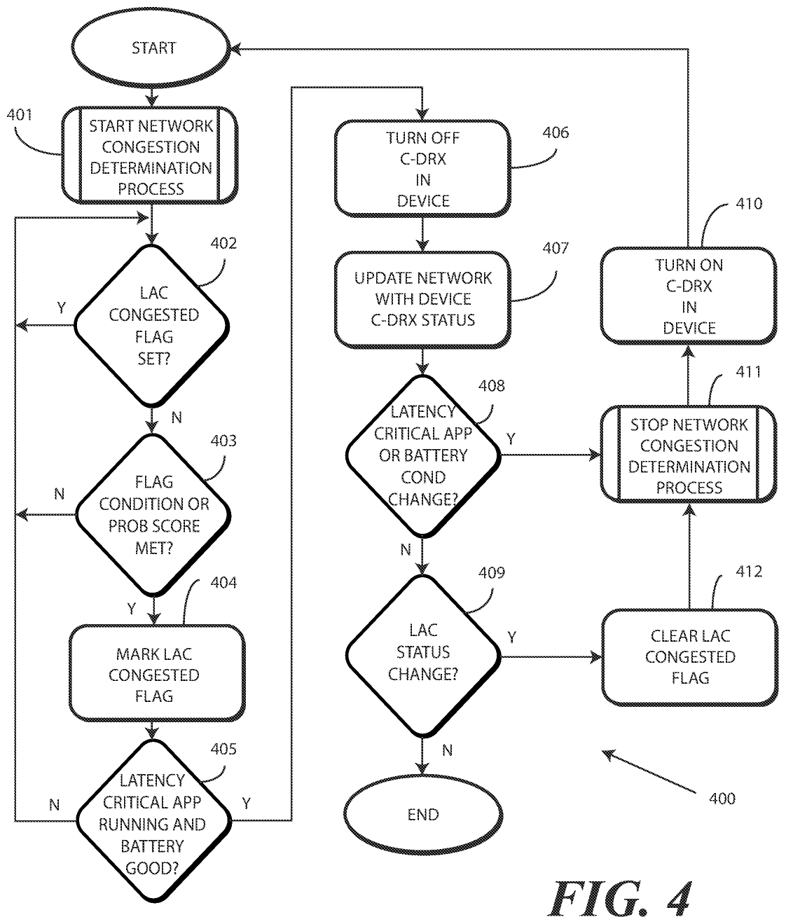

Turning now to FIG. 4, illustrated therein is another explanatory method 400 for disabling a C-DRX mode of operation under certain conditions in accordance with one or more embodiments of the disclosure. In one or more embodiments, the method 400 allows an electronic device to autonomously determine that network congestion exceeds a predefined threshold and then, in response, turn OFF a C-DRX mode of operation to allow the network to schedule resources more quickly until the user experience improves. In the illustrative embodiment of FIG. 4, this action is taken on a per-location area code [LAC] basis. Additionally, when a user has designated one or more applications to operate in “performance mode,” the method 400 can disable the C-DRX mode of operation whenever such an application having critical demands is operating and the electronic device has sufficient energy stored in the energy storage device or is charging.

The method 400 begins at stage 401, where the network congestion determination process is initiated. Accordingly, stage 401 begins the process of determining whether network congestion sufficiently exists to disable a C-DRX mode of operation.

Decision 402 then determines if the C-DRX mode of operation is already disabled by checking to see whether the LAC congested flag has been previously set. Said differently, decision 402 identifies whether a congestion flag, which is set on a per-LAC basis, has been set in a memory of the electronic device implementing the method 400 of FIG. 4. Where it has, this means the C-DRX mode of operation is disabled and the method 400 repeats since the remainder of the network congestion determination process is not required.

Otherwise, decision 403 determines whether network congestion exceeds a predefined threshold, or alternatively whether a network congestion probability score is met. The former can be performed using the triggers (300) shown in the table (500) FIG. 5 implemented in the formula (502) shown beside these triggers (300), pursuant to the examples (503). As shown in the formulae (502) of the table, in one or more embodiments the congestion flag can be set when any one of the following occur:
any one metric selected from a first class (weighted high) of metrics occurs, examples of which include a DNS response timeout, a DNS server change, and/or a TCP retransmission rate exceeding a predefined threshold such as thirty-five percent or a user defined variant of this predefined threshold;
any two metrics selected from a second class (weighted medium) of metrics having a lower categorization than the first class of metrics occurs, examples of which include an IP packet loss rate exceeding a predefined threshold such as twenty percent or a user defined variant of this predefined threshold, a TCP DUP ACK rate exceeding a predefined threshold such as fifty percent or a user defined variant of this predefined threshold, a PHY scheduling rate in an area of good RF quality, an IP packet jitter variation in latency exceeding a predefined threshold such as three times the normal latency or a user defined variant of this predefined threshold, and/or an IP packet latency such as an ICMP response timing out; or
any three metrics selected from a third class (weighted low) of metrics having a lower categorization than the second class of metrics occurs, examples of which include an IP segmentation rate exceeding a predefined threshold such as ten percent or a user defined variant of this predefined threshold, a distance to a node of the network exceeding a predefined threshold such as one mile or a user defined variant of this predefined threshold, and/or a location being a signal-inhibiting condition such as being indoors, in-pocket, or in a drawer as determined by one or more sensors of the electronic device. These examples are illustrative only, as other triggers (300) will be obvious to those of ordinary skill in the art having the benefit of this disclosure.

Using this formula (502), as shown in the examples (503) below, if a DNS query time out or a DNS server flipped, decision 403 would detect this and the method 400 would move to step 404 where the network congestion flag is set. Similarly, if the TCP transmission rate was above a predefined threshold such as thirty-five percent, decision 403 would detect this and the method 400 would move to step 404 where the network congestion flag is set. If PHY scheduling were not occurring and IP packet exceeded a predefined threshold such as twenty percent, decision 403 would detect this and the method 400 would move to step 404 where the network congestion flag is set, and so forth. These examples (503) are illustrative only, as others resulting from the formula (502) can be determined by those of ordinary skill in the art having the benefit of this disclosure.

When using a probabilistic approach, decision 403 can set the network congestion flag when a network congestion probability exceeds a predefined network congestion predefined threshold. This can be performed using the triggers (300) shown in the table (600) FIG. 6 implemented in the formulae (602) shown beside these triggers (300), pursuant to the examples (603) shown below. In one or more embodiments, the network congestion probability is determined by one of:
determining a first maximum metric from a first class (weighted high) of metrics, examples of which include a DNS response timeout, a DNS server change, and/or a TCP retransmission rate;
determining an average of a sum of the first maximum metric from the first class of metrics and a second maximum metric from a second class (weighted medium) having a lower categorization that the first class of metrics, examples of which include an IP packet loss rate, a TCP DUP ACK rate, a PHY scheduling rate in an area of good RF quality, an IP packet jitter variation in latency, and/or an IP packet latency such as an ICMP response; or
determining an average of another sum of the first maximum metric from the first class of metrics and the second maximum metric from the second class of metrics having the lower categorization than the first class of metrics and a third maximum metric from the third class of metrics (weighted low) having the lower categorization than the second class of metrics, examples of which include an IP segmentation rate, a distance to a node of the network, and/or a location being a signal-inhibiting condition such as being indoors, in-pocket, or in a drawer. These examples are illustrative only, as other triggers (300) will be obvious to those of ordinary skill in the art having the benefit of this disclosure.

Using these formulae (602), as shown in the examples (603) below, with a probabilistic threshold of fifty percent, if a DNS response timeout occurred, the probability score would exceed the predefined threshold. Decision 403 would detect this and the method 400 would move to step 404 where the network congestion flag is set. Similarly, if the DNS response timeout occurred and the PHY scheduling rate was seventy percent, the eighty-five percent probability score would exceed the predefined threshold. Decision 403 would detect this and the method 400 would move to step 404 where the network congestion flag is set. If the DNS response timeout occurred, and the PHY scheduling rate was seventy percent, and the IP packet segmentation rate was ten percent, the sixty percent probability score would exceed the predefined threshold. Decision 403 would detect this and the method 400 would move to step 404 where the network congestion flag is set.

Decision 405 then determines if a user has designated an application to be a performance mode application. Said differently, in one or more embodiments decision 405 determines whether user input identifying one or more applications for which the C-DRX mode of operation should be disabled to enhance performance on a per-application basis has been received. In one or more embodiments, the disabling occurs only when one or more data latency sensitive applications are operating on the one or more processors and the network congestion exceeds the predefined threshold or predefined probability score.

In one or more embodiments, decision 405 also determines whether the electronic device implementing the method 400 of FIG. 4 has an energy storage level of an energy storage device exceeding a predefined energy storage level threshold. Embodiments of the disclosure contemplate that it may be undesirable to turn OFF a C-DRX mode of operation when a battery is low since the C-DRX mode of operation's principal function is to conserve energy. Accordingly, in one or more embodiments the disablement of the C-DRX mode of operation occurs only when the one or more data latency sensitive applications are operating on the electronic device and an energy storage level of an energy storage device of the electronic device exceeds a minimum energy storage threshold and the network congestion exceeds the predefined threshold, as determined at decision 405.

Decision 405 can also determine whether the electronic device implementing the method 400 of FIG. 4 is connected to a charger. Embodiments of the disclosure contemplate that it may be undesirable to turn OFF a C-DRX mode of operation when a battery is low since the C-DRX mode of operation's principal function is to conserve energy. Accordingly, in one or more embodiments the disablement of the C-DRX mode of operation occurs only when the one or more data latency sensitive applications are operating on the electronic device and an energy storage level of the electronic device is connected to an external charger charging the energy storage device of the electronic device, as determined at decision 405.

Step 406 then disables the C-DRX mode of operation. In one or more embodiments, this occurs when network congestion exceeds a predefined threshold or predefined probability score. In other embodiments, this occurs when user input has identified one or more applications for which the C-DRX mode of operation should be disabled to enhance performance on a per-application basis and that application is operable on the one or more processors of the electronic device. Of course, this can happen automatically when one or more processors of the electronic device implementing the method 400 of FIG. 4 designate one or more applications as user-overridable performance applications that, when operating on the one or more processors, require the C-DRX mode of operation to be disabled as well.

Step 407 then updates the network with the C-DRX mode of operation status. In one or more embodiments, this step 407 informs the network that the C-DRX mode of operation is not supported such that the network understands there is no scheduling, and that the electronic device can be communicated with continuously. Decision 408 checks to see whether there has been a change in the latency critical application or whether the battery level is lower than the threshold, or whether the electronic device is no longer connected to a charger. Where any is true, the method moves to step 411. Otherwise, the network congestion determination process moves to decision 409.

Decision 409 determines whether the location of the electronic device implementing the method 400 of FIG. 4 has changed. Said differently, decision 409 determines whether the electronic device has entered a new network location. In one or more embodiments, the disabling of the C-DRX mode of operation occurring at step 406 continues so long as the network congestion exceeds the predefined threshold or when the electronic device enters a new network location. Where either occurs, step 412 clears the network congestion flag.

The C-DRX mode of operation is then re-enabled at step 410. Accordingly, in one or more embodiments step 410 comprises re-enabling the C-DRX mode of operation when the network congestion falls below the predefined threshold or when the electronic device enters a new network location. The method 400 can then repeat.

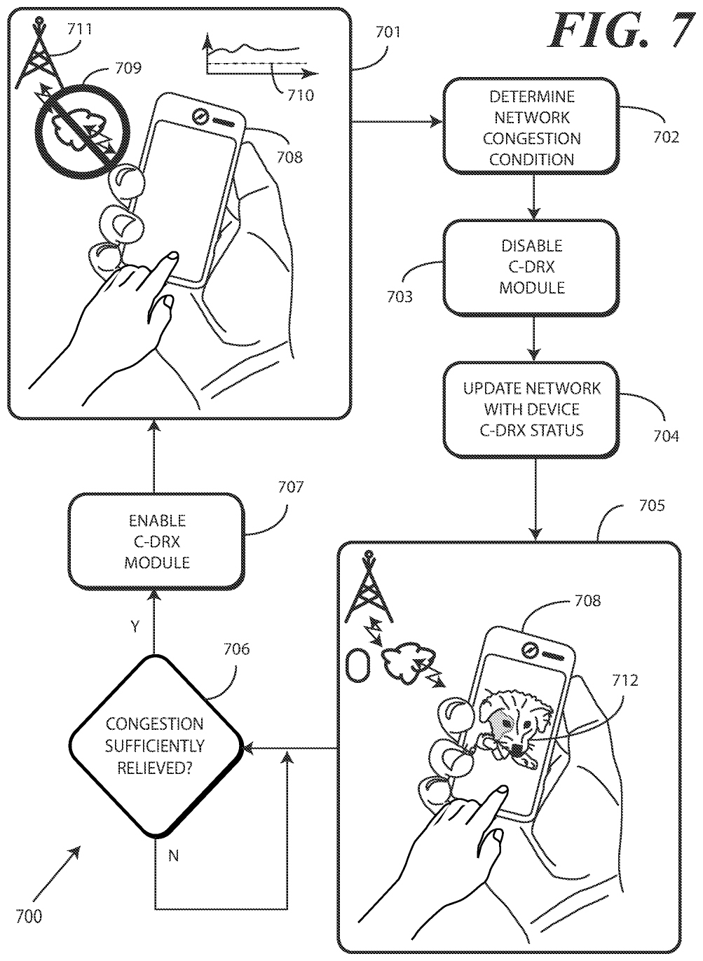

Turning now to FIG. 7, illustrated therein is another method 700 for disabling a C-DRX mode of operation in accordance with one or more embodiments of the disclosure. Beginning at step 701, network congestion 709 between an electronic device 708 and a network 711 exceeds a predefined threshold 710.

Step 702 determines this fact. In one or more embodiments, step 702 comprises one or more processors of the electronic device 708 determining this fact by inference from one or more IP and physical layer metrics that are weighed hierarchically, examples of which are shown above in FIG. 3 with hierarchical weighting shown above in the tables (500,600) of FIGS. 5. And 6.

Step 703 then disables the C-DRX mode of operation of the electronic device 708. In one or more embodiments, step 704 comprises transmitting a message across the network to a remote electronic device (e.g., node (126) of FIG. 1) indicating the C-DRX mode of operation is disabled. At step 705, this allows a user identified application 712 to operate on one or more processors of the electronic device 708 without throttling by the C-DRX mode of operation.

Step 705 shows thereafter that the network congestion 709 has cleared. Decision 706 thus comprises determining that the network congestion 709 has fallen below the predefined threshold 710. Accordingly, step 707 re-enables the C-DRX mode of operation. The method 700 can then repeat.

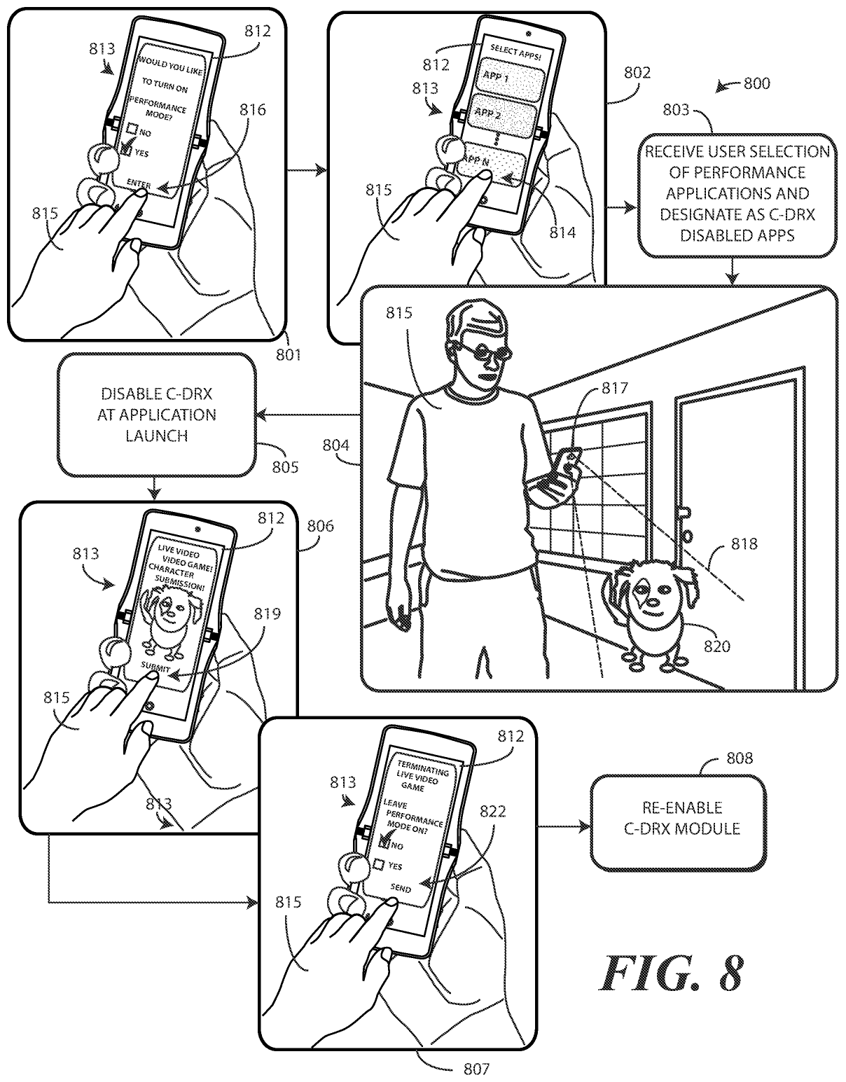

While FIG. 7 illustrates disablement of the C-DRX mode of operation in response to network congestion, the C-DRX mode of operation can also be disabled when user input is received at a user interface identifying, on a per-application basis, a user identified application that should operate in a “performance mode” and that user identified application is operating on the electronic device. Turning now to FIG. 8, illustrated therein is such a method 800.

Beginning at step 801, a user 815 is delivering user input 816 to a user interface 812 of an electronic device 813 identifying a user-identified application to operate in a performance mode. In one or more embodiments, this occurs on a per-application basis. In one or more embodiments, the “performance mode” identifies that the application is one for which the C-DRX mode of operation should be disabled. This fact need not be identified to the user 815. Instead, the “how” of the performance mode, e.g., disablement of the C-DRX mode of operation, may be hidden from the user 815. This user input is received at step 803.

At step 802, the user 815 launches the user-identified application 814 by selecting it on the user interface 812 of the electronic device 813. This causes the user-identified application 814 to run on the one or more processors of the electronic device 813 when the user input is received at step 803.

As shown at step 804, in this example the user-identified application 814 is a gaming application allowing video capture and character submission. In this example, the user 815 does not want to miss a minute of the antics of his dog, Buster 820, as the user 815 thinks Buster 820 would be a great character for the game. Accordingly, disablement of the C-DRX mode of operation, shown at step 805 occurring at the launch of the user-identified application 814 allows the user 815 to employ an image capture device 817 to capture and transmit high-quality videos 818 of Buster 820 to the gaming company for submission. Specifically, at step 806 the user 815 delivers user input 819 to the user interface 812 of the electronic device 813 to transmit the latest video.

While this example provides one illustrative “uplink” example, in other embodiments C-DRX disablement could offer a more visible benefit in the downlink direction where the electronic device 813 could be using more component carriers and MIMO resources than in the uplink direction. Accordingly, as demonstrated above with reference to FIG. 4, in other applications requiring both uplink and downlink data, such as if the user 815 were using an electronic tracker collar to track Buster 820 where data was flowing in both the uplink and downlink directions with low-latency being a must for real-time tracking, the real-time feedback provided by embodiments of the disclosure offers improved performance over systems where the C-DRX mode of operation cannot be disabled.

Step 807 can optionally present a prompt 822 at the user interface 812 of the electronic device 813 asking if the user 815 would like to leave the performance mode ON. Presuming this is not the case, step 808 re-enables the C-DRX mode of operation.

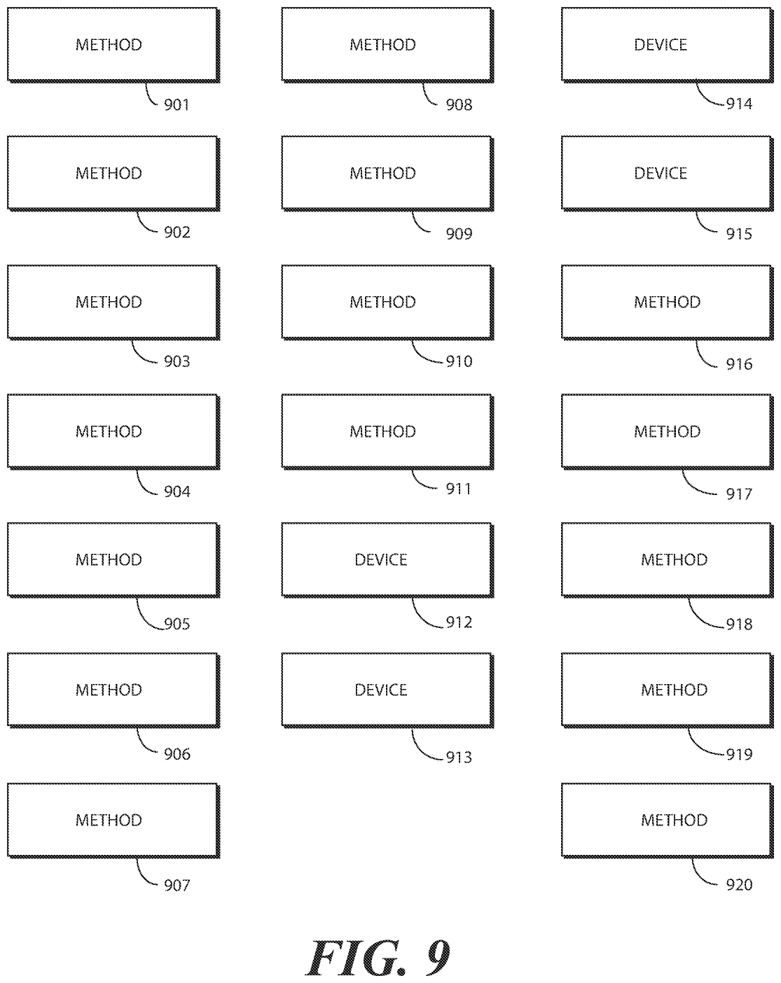

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises determining, by one or more processors of the electronic device, whether network congestion exceeds a predefined threshold. At 901, when the network congestion exceeds the predefined threshold, the method comprises disabling by the one or more processors a C-DRX mode of operation in the electronic device.

At 902, the disabling of 901 continues as long as the network congestion exceeds the predefined threshold. At 902, the method comprises re-enabling the C-DRX mode of operation when the network congestion falls below the predefined threshold or when the electronic device enters a new network location.

At 903, the disabling of 901 occurs only when one or more data latency sensitive applications are operating on the one or more processors and the network congestion exceeds the predefined threshold.

At 904, the method of 901 further comprises receiving, by a user interface, user input identifying one or more applications for which the C-DRX mode of operation should be disabled to enhance performance on a per-application basis. At 904, the method comprises disabling the C-DRX mode of operation while the one or more applications are operable on the one or more processors.

At 905, the disabling of 902 occurs only when the one or more data latency sensitive applications are operating on the electronic device, an energy storage level of an energy storage device of the electronic device exceeds a minimum energy storage threshold, and the network congestion exceeds the predefined threshold.

At 906, the disabling of 902 occurs only when the one or more data latency sensitive applications are operating on the electronic device, an energy storage device is connected to an external charger charging the energy storage device, and the network congestion exceeds the predefined threshold.

At 907, the determining of 901 comprises identifying whether a congestion flag has been set in a memory of the electronic device. At 908, the congestion flag of 907 is set when any of the following occur: any one metric selected from a first class of metrics occurs; any two metrics selected from a second class of metrics having a lower categorization than the first class of metrics occurs; or any three metrics selected from a third class of metrics having a lower categorization than the second class of metrics occurs.

At 909, the congestion flag of 907 is set when a network congestion probability exceeds a predefined network congestion probability threshold. At 910, the method of 909 further comprises determining the network congestion probability by one of: determining a first maximum metric from a first class of metrics; determining an average of a sum of the first maximum metric from the first class of metrics and a second maximum metric from a second class of metrics having a lower categorization than the first class of metrics; or determining an average of another sum of the first maximum metric from the first class of metrics and the second maximum metric from the second class of metrics having the lower categorization than the first class of metrics and a third maximum metric from the third class of metrics having the lower categorization than the second class of metrics.

At 911, the method of 901 further comprises the one or more processors designating one or more applications as user-overridable performance applications that, when operating on the one or more processors, require the C-DRX mode of operation to be disabled.

At 912, an electronic device comprises a communication device and one or more processors operable with the communication device. At 912, the one or more processors infer whether network congestion exceeds a predefined threshold from one or more IP and physical layer metrics and disabling a C-DRX mode of operation when the network congestion exceeds the predefined threshold.

At 913, the one or more processors of 912 infer whether the network congestion exceeds the predefined threshold by weighting the one or more IP and physical layer metrics hierarchically as one or more weighted metrics. At 914, the one or more processors of 913 further infer whether the network congestion exceeds the predefined threshold by calculating a network congestion probability score from the one or more weighted metrics.

At 915, the electronic device of 913 further comprises an energy storage device. At 915, the disabling occurs only when a latency-sensitive application is operating on the one or more processors and the energy storage device is charging or has an energy storage level exceeding an energy storage threshold.

At 916, a method in an electronic device comprises disabling a C-DRX mode of operation in the electronic device when one of one or more processors of the electronic device determine that network congestion exceeds the predefined threshold, or a user-identified application is operating on the one or more processors.

At 917, the method of 916 further comprises receiving, at a user interface, user input identifying the user-identified application as a performance application on a per-application basis. At 918, the method of 916 further comprises enabling the C-DRX mode ofe operation when one of the one or more processors of the electronic device determine that the network congestion falls below the predefined threshold or the user-identified application ceases operating on the one or more processors.

At 919, the disabling of 916 only occurs when an energy storage device of the electronic device is charged beyond a predefined energy storage threshold or is connected to a charger. At 920, the one or more processors of 916 determine the network congestion exceeds the predefined threshold by inference from one or more IP and physical layer metrics that are weighted hierarchically.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, the method comprising:
determining, by one or more processors of the electronic device, whether network congestion exceeds a predefined threshold; and
when the network congestion exceeds the predefined threshold disabling, by the one or more processors a connected mode discontinuous reception (C-DRX) mode of operation in the electronic device.

2. The method of claim 1, wherein the disabling continues as long as the network congestion exceeds the predefined threshold and re-enabling the C-DRX mode of operation when the network congestion falls below the predefined threshold or when the electronic device enters a new network location.

3. The method of claim 1, wherein the disabling occurs only when one or more data latency sensitive applications are operating on the one or more processors and the network congestion exceeds the predefined threshold.

4. The method of claim 1, further comprising:
receiving, by a user interface, user input identifying one or more applications for which the C-DRX mode of operation should be disabled to enhance performance on a per-application basis; and
disabling the C-DRX mode of operation while the one or more applications are operable on the one or more processors.

5. The method of claim 2, wherein the disabling occurs only when the one or more data latency sensitive applications are operating on the electronic device, an energy storage level of an energy storage device of the electronic device exceeds a minimum energy storage threshold, and the network congestion exceeds the predefined threshold.

6. The method of claim 2, wherein the disabling occurs only when the one or more data latency sensitive applications are operating on the electronic device, an energy storage device is connected to an external charger charging the energy storage device, and the network congestion exceeds the predefined threshold.

7. The method of claim 1, wherein the determining comprises identifying whether a congestion flag has been set in a memory of the electronic device.

8. The method of claim 7, wherein the congestion flag is set when any of the following occur:
any one metric selected from a first class of metrics occurs;
any two metrics selected from a second class of metrics having a lower categorization than the first class of metrics occurs; or
any three metrics selected from a third class of metrics having a lower categorization than the second class of metrics occurs.

9. The method of claim 7, wherein the congestion flag is set when a network congestion probability exceeds a predefined network congestion probability threshold.

10. The method of claim 9, further comprising determining the network congestion probability by one of:
determining a first maximum metric from a first class of metrics;
determining an average of a sum of the first maximum metric from the first class of metrics and a second maximum metric from a second class of metrics having a lower categorization than the first class of metrics; or
determining an average of another sum of the first maximum metric from the first class of metrics and the second maximum metric from the second class of metrics having the lower categorization than the first class of metrics and a third maximum metric from a third class of metrics having the lower categorization than the second class of metrics.

11. The method of claim 1, further comprising the one or more processors designating one or more applications as user-overridable performance applications that, when operating on the one or more processors, require the C-DRX mode of operation to be disabled.

12. An electronic device, comprising:
a communication device; and
one or more processors operable with the communication device;
the one or more processors inferring whether network congestion exceeds a predefined threshold from one or more Internet-protocol (IP) and physical layer metrics and disabling a C-DRX mode of operation when the network congestion exceeds the predefined threshold.

13. The electronic device of claim 12, the one or more processors inferring whether the network congestion exceeds the predefined threshold by weighting the one or more IP and physical layer metrics hierarchically as one or more weighted metrics.

14. The electronic device of claim 13, the one or more processors further inferring whether the network congestion exceeds the predefined threshold by calculating a network congestion probability score from the one or more weighted metrics.

15. The electronic device of claim 13, further comprising an energy storage device, wherein the disabling occurs only when a latency-sensitive application is operating on the one or more processors and the energy storage device is charging or has an energy storage level exceeding an energy storage threshold.

16. A method in an electronic device, the method comprising disabling a C-DRX mode of operation in the electronic device when one of:
one or more processors of the electronic device determine that network congestion exceeds a predefined threshold; or
a user-identified application is operating on the one or more processors.

17. The method of claim 16, further comprising receiving, at a user interface, user input identifying the user-identified application as a performance application on a per-application basis.

18. The method of claim 16, further comprising enabling the C-DRX mode of operation when one of:
the one or more processors of the electronic device determine that the network congestion falls below the predefined threshold; or
the user-identified application ceases operating on the one or more processors.

19. The method of claim 16, wherein the disabling only occurs when an energy storage device of the electronic device is charged beyond a predefined energy storage threshold or is connected to a charger.

20. The method of claim 16, wherein the one or more processors determine the network congestion exceeds the predefined threshold by inference from one or more IP and physical layer metrics that are weighted hierarchically.
